(19) United States
(12) Patent Application Publication
(10) Pub. No.: US 2017/0146892 A1
(43) Pub. Date: May 25, 2017

(54) CAMERA STABILIZER WITH CHANGEABLE STRUCTURE

(71) Applicant: Guilin Feiyu Technology Corporation Ltd., Guilin (CN)

(72) Inventor: Chengyun Wei, Guilin (CN)

(21) Appl. No.: 15/212,202

(22) Filed: Jul. 16, 2016

(30) Foreign Application Priority Data
Nov. 23, 2015 (CN) 201520939540.6

(51) Int. Cl. G03B 17/56; F16M 11/04; F16M 11/18; F16M 11/12; F16M 13/04

(52) U.S. Cl. CPC G03B 17/561; G03B 17/563; F16M 11/12; F16M 13/04; F16M 11/18; F16M 11/045; F16M 11/046; F16M 11/048

(57) ABSTRACT

A camera stabilizer with a changeable structure comprises an X-axis drive device, a Y-axis drive device and a Z-axis drive device, which are perpendicular to one another and can be rotated 360 degrees. The Z-axis drive device is connected with Y-axis drive device via a first connecting arm, the Y-axis drive device is connected with X-axis drive device via a second connecting arm, and the X-axis drive device is connected with a fixing device. The disclosed camera stabilizer has three shafts which can rotate 360 degrees, and a fixing device for mounting different types of mirrorless cameras. By adjusting the three control shafts, the gravity center of the camera can be adjusted to achieve mechanical stabilization. By changing the configuration of the handheld part, the camera stabilizer can be switched between a single hand-held mode and a two hand-held mode and between a forward mode and a reverse mode.

### CROSS REFERENCE TO RELATED APPLICATIONS

The present application claims the benefit of Chinese utility model application No. 201520939540.6 filed on Nov. 23, 2015, all the contents of which are hereby incorporated by reference.

### FIELD OF THE INVENTION

The present invention relates to the technical field of shooting equipment, more particularly to a camera stabilizer with a changeable structure.

### BACKGROUND OF THE INVENTION

Camera stabilizer is a support platform for installing the camera, and the camera is usually arranged on the camera stabilizer. By adjusting the camera stabilizer, the camera lens can be adjusted to achieve desired shooting of targets.

The existing camera stabilizers may only rotate about three axes and the camera lens can be adjusted only in a stationary position. The existing camera stabilizers cannot provide a real-time stabilizing compensation during moving shooting, and cannot solve the technical problem of unstabilized camera caused by unstabilized mobile platform during moving shooting. Moreover, the existing camera stabilizers cannot achieve 360 degrees rotation and have poor stabilization effects.

### SUMMARY OF THE INVENTION

To this end, the present invention provides a camera stabilizer with a changeable structure, solving the disadvantages of existing camera stabilizers which cannot be rotated 360 degrees and have poor stability.

In order to solve the above technical problems, the present invention provides technical solutions as follows:

A camera stabilizer with a changeable structure according to the present invention comprises an X-axis drive device, a Y-axis drive device and a Z-axis drive device which are perpendicular to one another, wherein the Z-axis drive device is connected with the Y-axis drive device via a first connecting arm, the Y-axis drive device is connected with the X-axis drive device via a second connecting arm, and the X-axis drive device is connected with a fixing device, wherein the X-axis drive device, the Y-axis drive device and the Z-axis drive device can be rotated 360 degrees.

Preferably, the fixing device comprises a fix screw, a horizontal fixing plate, and an arc-shaped fixing band perpendicularly arranged on the edge of the fixing plate. The fixing plate is arranged with mounting grooves for fixing camera lens. The fix screw can be passed through the mounting grooves to fix camera lens, and thus different types of cameras can be fixed by mounting the fix screw at different positions on the fixing plate.

Preferably, the first connecting arm, the second connecting arm, and the fixing device are respectively and accordingly connected to the X-axis drive device, the Y-axis drive device, and the Z-axis drive device via elasticity filature. By sliding the elasticity filature, the positions where the X-axis drive device, the Y-axis drive device, and the Z-axis drive device are connected can be changed, thereby adjusting the gravity center of the stabilizer.

Preferably, the drive devices are motors, each of which comprises a hollow bearing, a slip ring and a control line, wherein the control line is passed through the slip ring and is connected to hollow shaft, and the motors can be rotated 360 degrees.

Preferably, a handheld part connected with the Z-axis drive device is further provided.

Preferably, the handheld part comprises a handle, and a function button and a navigation key which are arranged on the handle.

Preferably, the handheld part comprises a joint lever arranged with a function button and a navigation key, and a three-direction handle connected with the joint lever.

Preferably, the three-direction handle comprises a first handle, a second joint lever and a third joint lever, all of which are connected by a T-pipe, wherein the first handle is perpendicular to the second joint lever and the third joint lever, and the second joint lever and the third joint lever respectively have two ends respectively connected with a second handle and a third handle.

The camera stabilizer with a changeable structure according to the present invention has advantages as follows:

1. With the X-axis drive device, the Y-axis drive device and the Z-axis drive device, which are perpendicular to one another and can be rotated 360 degrees, the camera stabilizer can be adjusted and rotated 360 degrees in three-dimensional space and thus facilitates multi-angle shooting of the stabilizer.

2. By adjusting the distances between the control shafts of the X-axis drive device, the Y-axis drive device and the Z-axis drive device by means of elasticity filature, the camera stabilizer has three adjustable shafts and thus the gravity center of the camera can be adjusted.

3. By mounting screws at different positions on the fixing plate, different types of mirrorless cameras can be mounted to the fixing device. The installation is easy and convenient.

4. By changing the configuration of the handheld part, the camera stabilizer can be switched between a single hand-held mode and a two hand-held mode and between a forward mode and a reverse mode.

5. By changing the configuration of the handheld part, the camera stabilizer with a changeable structure according to the present invention can be used as a machine-mounted camera stabilizer.

6. The camera stabilizer with a changeable structure according to the present invention can be used as a two-axis stabilizer or a machine-mounted stabilizer.

### BRIEF DESCRIPTION OF THE DRAWINGS

The present invention will be further explained below in detail with reference to figures and embodiments.

FIG. 1 is a structure diagram of a camera stabilizer with a changeable structure according to an embodiment of the present invention.

FIG. 2 is a structure diagram of a camera stabilizer with a changeable structure according to another embodiment of the present invention.

In the figures:

1. fixing band; 2. fixing plate; 3. fix screw; 4. elasticity filature; 5. first connecting arm; 6. Z-axis drive device; 7. function button; 8. navigation key; 9. handle; 10. X-axis drive device; 11. second connecting arm; 12. Y-axis drive device; 13. second handle; 14. second joint lever; 15. T-pipe; 16. third joint lever; 17. first handle; 18. third handle; 19. joint lever.

### DETAILED DESCRIPTION OF ILLUSTRATED EMBODIMENTS

In order to make the purpose, technical solutions and advantages of the invention clearer, the technical solutions of the present invention are clearly and fully described as below. Apparently, the described embodiments are merely a part rather than all of the embodiments of the invention. All other embodiments obtained by persons with ordinary skills in the art based on the embodiments of the present invention without creative efforts shall fall within the protection scope of the present invention.

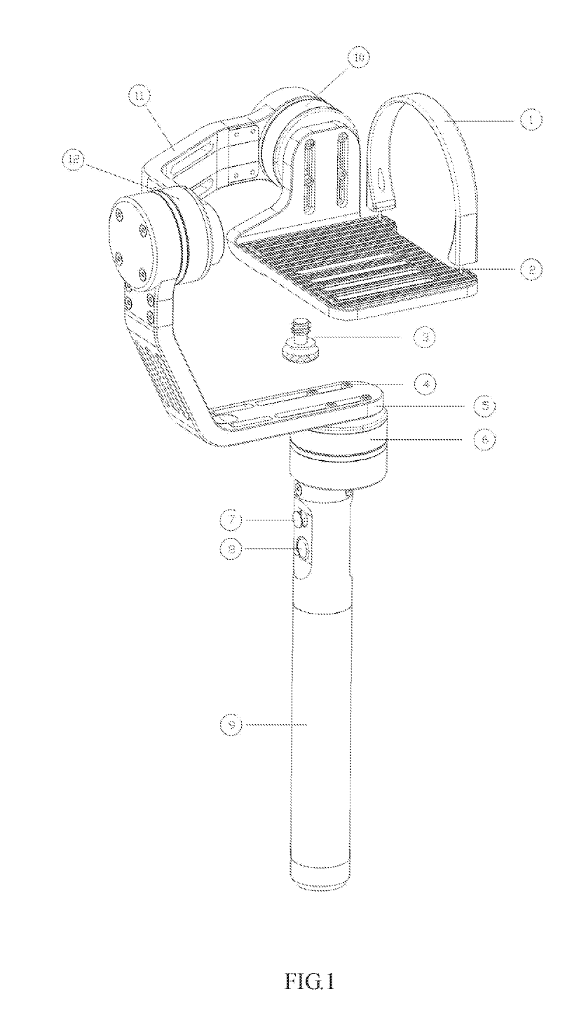

The present invention will be further explained below in detail with reference to figures. As shown in FIG. 1, a camera stabilizer with a changeable structure according to an embodiment of the present invention comprises an X-axis drive device 10 for controlling pitching movement, a Y-axis drive device 12 for controlling rolling movement, and a Z-axis drive device 6 for controlling yawing movement, all of which are perpendicular to one another and are orthogonal in space. The Z-axis drive device 6 is connected with the Y-axis drive device 12 via a first connecting arm 5, the Y-axis drive device 12 is connected with the X-axis drive device 10 via a second connecting arm 11, and the X-axis drive device 10 is connected with a fixing device, wherein all of the X-axis drive device, the Y-axis drive device and the Z-axis drive device can be rotated 360 degrees.

In a preferred embodiment, the fixing device comprises a fix screw 3, a horizontal fixing plate 2, and an arc-shaped fixing band 1 perpendicularly arranged on the edge of the fixing plate 2, wherein the fixing plate 2 is arranged with mounting grooves for fixing camera lens. The fix screw 3 can be passed through the mounting grooves and fixed to installation screw holes of mirrorless camera, whereby mirrorless camera lens can be fixed. The fixing band 1 is used for fixing camera lens. Different types of cameras have installation screw holes at different positions, and different types of mirrorless cameras can be mounted by the fixing device with mounting grooves at different positions. Different types of cameras can be mounted by fix screws 3 arranged at different positions on the fixing plate. In a preferred embodiment, the first connecting arm 5, the second connecting arm 11, and the fixing device are respectively and accordingly connected to the X-axis drive device 10, the Y-axis drive device 12, and the Z-axis drive device 6 via elasticity filature 4. By sliding the elasticity filature 4, the positions where the X-axis drive device 10, the Y-axis drive device 12, and the Z-axis drive device 6 are connected can be adjusted, thereby adjusting the gravity center of the stabilizer to achieve mechanical stabilization.

In a preferred embodiment, the X-axis drive device, the Y-axis drive device and the Z-axis drive device are motors, each of which comprises a hollow bearing, a slip ring and a control line. The control line is passed through the slip ring and hollow shaft. With the hollow bearing and the slip ring mechanism, the control line can be passed through the hollow bearing of the slip ring, and through the brushless motor, to achieve direct internal threading of axes, facilitate 360 degrees free rotation of the motor and prevent fraying and twining of the control line. Furthermore, the distances between the control shafts of the three motors are adjusted by means of the elasticity filature 4, whereby the gravity center of the camera can be adjusted and the motors can be adjusted in terms of the three axes.

In a preferred embodiment, the camera stabilizer with a changeable structure according to the present invention further comprises a handheld part connected with the Z-axis drive device 6. In the present invention, with a changeable structure of the handheld part, the camera stabilizer can be switched between a single hand-held mode and a two hand-held mode and between a forward mode and a reverse mode.

As shown in FIG. 1, the handheld part is in a reverse mode to form a single hand-held mechanism. The handheld part comprises an upright handle 9, and a function button 7 and a navigation key 8 which are arranged on the handle 9. The handle 9 is connected with the Z-axis drive device 6 via screws. Thereinto, the working modes of the stabilizer can be switched by the function button 7. The function button 7 may be arranged with an indicator light for indicating the working modes. The stabilizer mainly has three working modes, i.e. a yaw-following mode, a yaw and pitch following mode, and a locking mode. By means of the navigation key 8, the rotations of the X-axis drive device, the Y-axis drive device and the Z-axis drive device about three axes can be controlled.

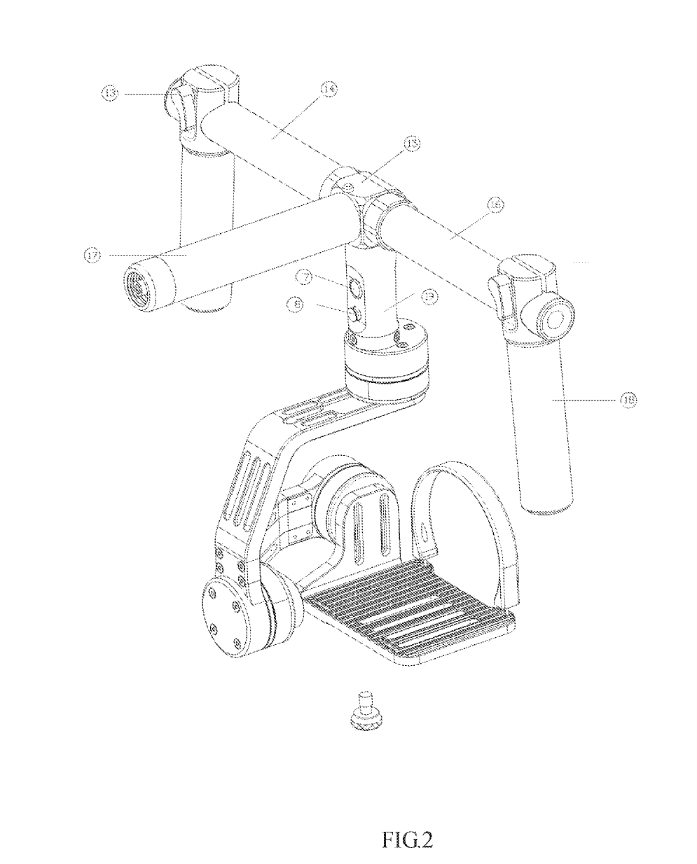

As shown in FIG. 2, the handheld part is in a forward mode to form a two hand-held mechanism. The handheld part comprises a joint lever 19 arranged with a function button 7 and a navigation key 8, and a three-direction handle connected with the joint lever 19. The three-direction handle comprises a first handle 17, a second joint lever 14 and a third joint lever 16, all of which are connected by a T-pipe 15. The first handle 17 is perpendicular to the second joint lever 14 and the third joint lever 16, and the second joint lever 14 and the third joint lever 16 respectively have two ends respectively connected with a second handle 13 and a third handle 18.

Compared with existing devices, the camera stabilizer with a changeable structure according to the present invention has advantages as follows:

1. Since the X-axis drive device, the Y-axis drive device and the Z-axis drive device are perpendicular to one another and can be rotated 360 degrees, and preferably are motors with hollow bearing and slip ring mechanism, and with control line being passed through the hollow bearing of the slip ring and through the brushless motor to achieve direct internal threading of axes, the camera stabilizer can be adjusted and rotated 360 degrees in three-dimensional space due to 360 degrees free rotation of the motors and thus has an improved stability.

2. By adjusting the distances between the control shafts of the X-axis drive device, the Y-axis drive device and the Z-axis drive device by means of elasticity filature, the camera stabilizer has three adjustable shafts and thus the gravity center of the camera can be adjusted.

3. The fixing device has mounting grooves arranged at different positions. By mounting fix screws passing through the mounting grooves which have positions corresponding to the positions of installation screw holes of cameras, and through the installation screw holes of cameras, different types of mirrorless cameras can be mounted to the fixing device. The installation is easy and convenient.

4. The handheld part has two different assembled structures as shown in FIGS. 1 and 2. By changing the configuration of the handheld part, the camera stabilizer can be switched between a single hand-held mode and a two hand-held mode and between a forward mode and a reverse mode.

5.By changing the configuration of the handheld part, the camera stabilizer with a changeable structure according to the present invention can be used as a machine-mounted camera stabilizer.

6. The camera stabilizer with a changeable structure according to the present invention can be used as a two-axis stabilizer.

All the above embodiments are for illustrative purposes only, but are not to limit the invention in any form. Although the present invention has been described as above with reference to preferred embodiments, it should be understood that those skilled in the art may change or modify the technical solutions, and the present invention is intended to cover all changes, various modifications and equivalent arrangements made by those skilled in the art included within the principle and scope of the present invention according to the technical essence of the present invention.

What is claimed is:

1. A camera stabilizer with a changeable structure, comprising: an X-axis drive device, a Y-axis drive device and a Z-axis drive device which are perpendicular to one another, wherein the Z-axis drive device is connected with the Y-axis drive device via a first connecting arm, the Y-axis drive device is connected with the X-axis drive device via a second connecting arm, and the X-axis drive device is connected with a fixing device, wherein the X-axis drive device, the Y-axis drive device and the Z-axis drive device can be rotated 360 degrees, wherein the fixing device comprises a fix screw, a horizontal fixing plate, and an arc-shaped fixing band perpendicularly arranged on the edge of the fixing plate, the fixing plate is arranged with mounting grooves for fixing camera lens, the fix screw is passed through the mounting grooves to fix camera lens, such that different types of cameras can be fixed when the fix screw is mounted at different positions on the fixing plate.

2. The camera stabilizer with a changeable structure according to claim 1, characterized in that: the first connecting arm, the second connecting arm, and the fixing device are respectively and accordingly connected to the X-axis drive device, the Y-axis drive device, and the Z-axis drive device via elasticity filature, and the positions where the X-axis drive device, the Y-axis drive device and the Z-axis drive device are connected can be adjusted by sliding the elasticity filature, thereby adjusting the gravity center of the stabilizer.

3. The camera stabilizer with a changeable structure according to claim 1, characterized in that: the drive devices are motors respectively comprising a hollow bearing, a slip ring and a control line, wherein the control line is passed through the slip ring and is connected to hollow shaft, and the motors can be rotated 360 degrees.

4. The camera stabilizer with a changeable structure according to claim 1, characterized in that: it further comprises a handheld part connected with the Z-axis drive device.

5. The camera stabilizer with a changeable structure according to claim 2, further comprising a handheld part connected with the Z-axis drive device.

6. The camera stabilizer with a changeable structure according to claim 3, further comprising a handheld part connected with the Z-axis drive device.

7. The camera stabilizer with a changeable structure according to claim 4, characterized in that: the handheld part comprises a handle, and a function button and a navigation key which are arranged on the handle.

8. The camera stabilizer with a changeable structure according to claim 5, characterized in that: the handheld part comprises a handle, and a function button and a navigation key which are arranged on the handle.

9. The camera stabilizer with a changeable structure according to claim 6, characterized in that: the handheld part comprises a handle, and a function button and a navigation key which are arranged on the handle.

10. The camera stabilizer with a changeable structure according to claim 4, characterized in that: the handheld part comprises a joint lever and a three-direction handle connected with the joint lever, wherein the joint lever is arranged with a function button and a navigation key.

11. The camera stabilizer with a changeable structure according to claim 5, characterized in that: the handheld part comprises a joint lever and a three-direction handle connected with the joint lever, wherein the joint lever is arranged with a function button and a navigation key.

12. The camera stabilizer with a changeable structure according to claim 6, characterized in that: the handheld part comprises a joint lever and a three-direction handle connected with the joint lever, wherein the joint lever is arranged with a function button and a navigation key.

13. The camera stabilizer with a changeable structure according to claim 10, characterized in that: the three-direction handle comprises a first handle, a second joint lever and a third joint lever, all of which are connected by a T-pipe, wherein the first handle is perpendicular to the second joint lever and the third joint lever, and the second joint lever and the third joint lever respectively have two ends respectively connected with a second handle and a third handle.

14. The camera stabilizer with a changeable structure according to claim 11, characterized in that: the three-direction handle comprises a first handle, a second joint lever and a third joint lever, all of which are connected by a T-pipe, wherein the first handle is perpendicular to the second joint lever and the third joint lever, and the second joint lever and the third joint lever respectively have two ends respectively connected with a second handle and a third handle.

15. The camera stabilizer with a changeable structure according to claim 12, characterized in that: the three-direction handle comprises a first handle, a second joint lever and a third joint lever, all of which are connected by a T-pipe, wherein the first handle is perpendicular to the second joint lever and the third joint lever, and the second joint lever and the third joint lever respectively have two ends respectively connected with a second handle and a third handle.
